(19) United States
(12) Patent Application Publication
(10) Pub. No.: US 2011/0272831 A1
(43) Pub. Date: Nov. 10, 2011

(54) Wastewater treatment system

(76) Inventors: Robert Noel Pearson, Hattiesburg, MS (US); Michael Stephen Bonner, Hattiesburg, MS (US); Christopher Michael Bonner, Hattiesburg, MS (US)

(21) Appl. No.: 12/799,873

(22) Filed: May 4, 2010

(51) Int. Cl. B01F 3/04

(52) U.S. Cl. 261/120; 210/150; 261/124

(57) ABSTRACT

A wastewater treatment system for deployment within a pond having a floor and a wastewater surface is formed from a plurality of floating modular aeration units that are fluidly connected to a motorized blower via a central air delivery line. Each of the floating modular aeration units has an aeration grid retained below the wastewater surface and configured to form air bubbles below the wastewater surface. A buoyant frame retains the aeration grid above the floor of the water pond at a pre-determined depth. Pressurized air is delivered to the aeration grid forcing air bubbles to rise through the water column to the surface and supply oxygen to the pond.

### BACKGROUND OF THE INVENTION

The present invention relates to wastewater treatment systems, and more particularly to a floating aeration pod that delivers diffused air from below the water surface.

In the wastewater industry, facilities must make sure their effluent stream is in compliance with state and federal environmental guidelines. The guidelines are made based on several analyses including biochemical oxygen demand, or BOD, chemical oxygen demand (COD), total suspended solids (TSS), nitrogen (N), phosphorus (P), ammonia and other pollutants. Treatment of the wastewater reduces the concentration of these parameters to within acceptable ranges. For a wastewater pond to function properly, it must have the means to hold an incoming stream for a period of time and provide mechanical mixing and aeration. Usually, retention is available but not the mixing.

The conventional way to aerate the wastewater pond was to use a paddle wheel or some variance thereof. This type of mixing works to some capacity but only moves approximately the top three feet of water often leaving more than a third of the water undisturbed. A second type of aeration currently in use is accomplished by use of diffused air at the bottom of the waste water lagoon. Although diffused air is the best method to treat wastewater, treating from the bottom allows obstructions and clogging to occur. In addition, the types of devices being used to supply diffused air do not provide the ability to direct the flow of the waste stream to help extend the retention and treatment.

Thus, a floating aeration pod that uses diffused air to deliver air bubbles to a water level near the bottom of the wastewater lagoon is desired in order to solve the aforementioned problems.

### SUMMARY OF THE INVENTION

It is therefore an object of the present invention to provide a waste water system capable of delivering aeration to a level adjacent a bottom of a wastewater lagoon.

It is another object of the invention to provide a modular wastewater aeration system that can be deployed in a wastewater lagoon, with modular units being connected in a variety of desired configurations.

It is another object of the present invention to provide a wastewater treatment system, where individual modular units can be adjustably positioned to protect the delivery system from becoming clogged.

These and other objects of the invention are achieved through a provision of a wastewater treatment system for deployment within a pond having a floor and a wastewater surface is formed from a plurality of floating modular aeration units that are fluidly connected to a motorized blower via a central air delivery line. Each of the floating modular aeration units has an aeration grid retained below the wastewater surface and configured to form air bubbles below the wastewater surface. A buoyant frame retains the aeration grid above the floor of the water pond at a pre-determined depth. Pressurized air is delivered to the aeration grid forcing air bubbles to rise through the water column to the surface and supply oxygen to the pond.

These and other features of the present invention will become readily apparent upon further review of the following specifications and drawings.

### BRIEF DESCRIPTION OF THE DRAWINGS

FIG. 1 is a schematic view illustrating the wastewater treatment of the present invention.

FIG. 2 is a schematic view illustrating a modular aeration unit forming a part of the system of the present invention.

FIG. 3 is a top view of a buoyant frame forming a part of the modular aeration unit.

FIG. 4 is a perspective view of an aeration grid forming a part of the aeration unit.

FIG. 5 is a schematic view illustrating a flow diagram of an air blower that forms a part of the system of the present invention.

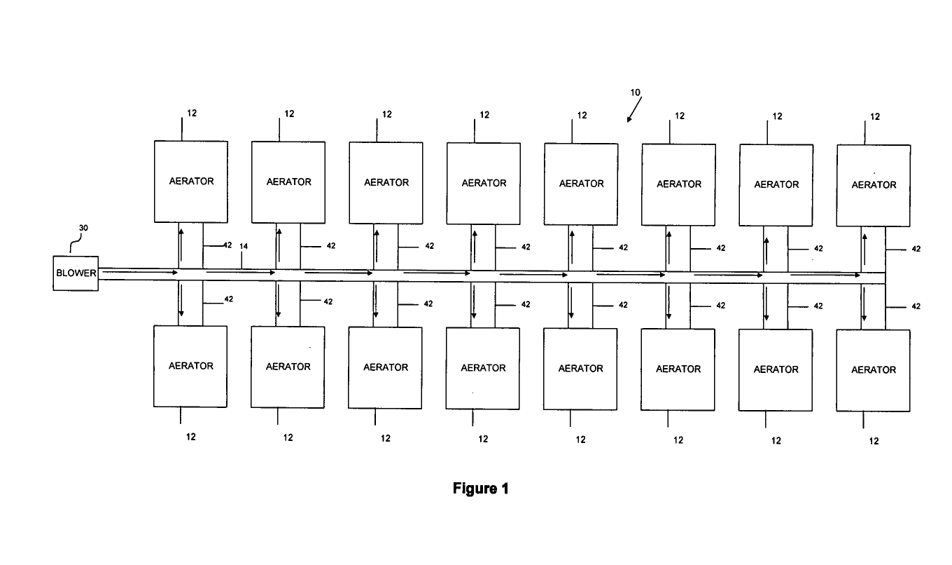

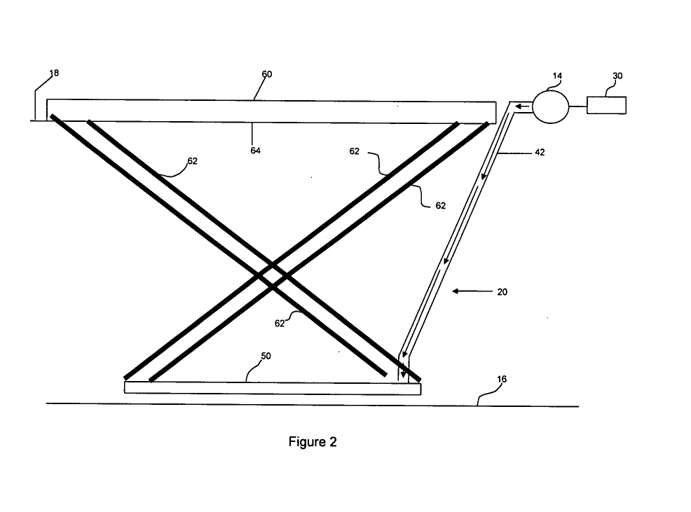

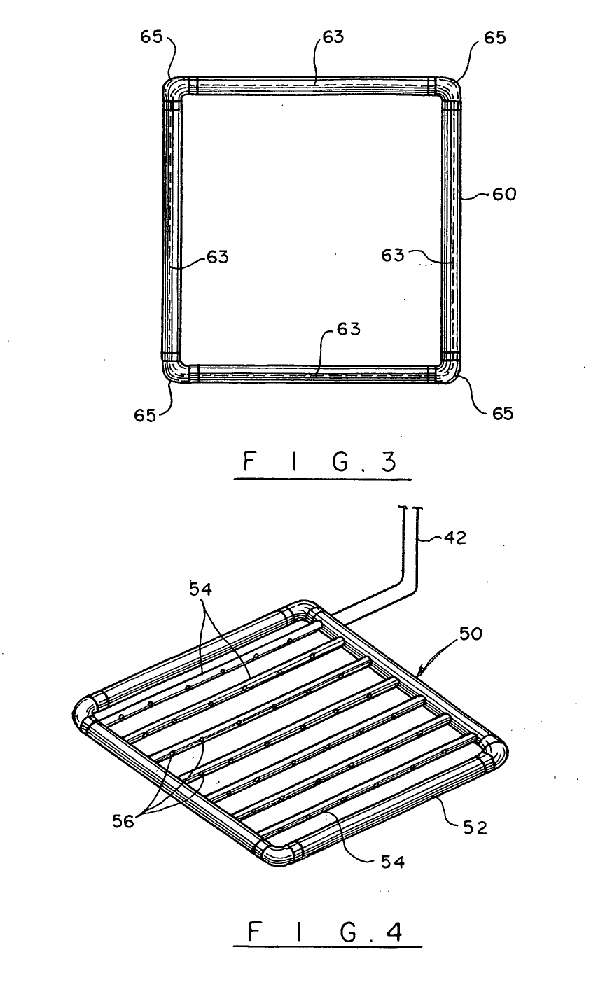

### DETAIL DESCRIPTION OF THE INVENTION

Turning now to the drawings in more detail, numeral 10 designates the wastewater treatment system of the present invention. The system 10 comprises a plurality of floating modular aeration units 12 operationally connected to a central air conduit 14.

The system 10 is configured to be deployed in a wastewater pond 20, which can be a body of water surrounded by a plurality of earthen or artificial barriers (not shown) and floor 16. Alternatively, the pond 20 may be formed from a variety of materials such as concrete, metals or plastics. In addition, the pond 20 may have a variety of depths and configurations. As can be appreciated, the pond 20 may be natural or man-made. A pond 20 may contain one or more treatment systems 10.

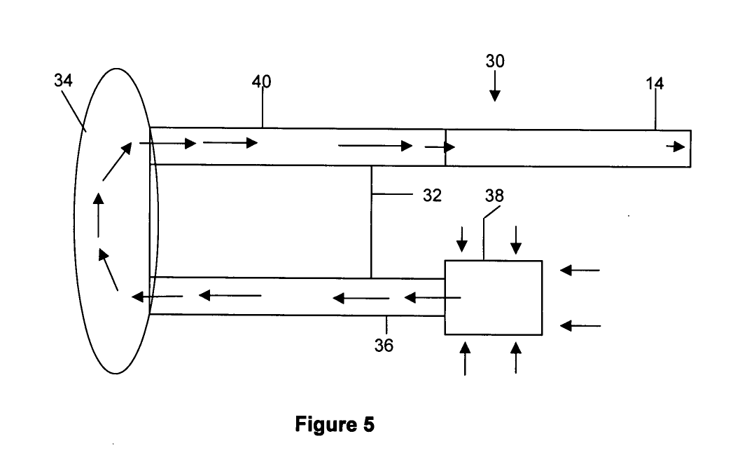

The central air conduit 14 is fluidly connected to a blower assembly 30, which can be an electrically powered device having a motor 32 that operates a fan 34. As can be seen in FIG. 5, an inlet air line 36 receives air from outside of the blower assembly 30 after the air has been directed through an air filter assembly 38. The air filter assembly 38 prevents contaminants, dust and debris from entering the air blower assembly 30 and clogging air diffuser openings, as will be explained in more detail hereinafter.

The arrows in FIG. 5 illustrate the path of air through the blower assembly 30. The motor 32 causes the fan 34 to transport a pressurized air flow from the inlet air line 36 to an outlet air line 40, which is in turn connected to the central air conduit 14. From there, the air flow is delivered to each modular aeration unit 12 via a separate air supply conduit 42. The air supply conduit 42 can be formed from a EPDM rubber with a polyurethane helix for crush protection.

The air supply conduit 42 is fluidly connected to an aeration grid member 50 of each modular aeration unit 12. The aeration grid member 50 comprises a tubular aeration frame 52, which can be of rectangular, circular or other configuration. The aeration frame 52 is fluidly connected to a plurality of aeration conduits 54 which extend between the aeration frame sides in any desired manner. Each of the aeration conduits 54 is provided with a plurality of openings 56, which diffuse the air flow and form fine bubbles that rise through the column of water in the pond 20. The blower 30 maintains pressure in the aeration conduits 54 forcing the air bubbles out of the aeration conduits 54.

Alternatively, the aeration grid 50 can be formed as a disc or plate with multiple openings capable of producing air bubbles as a result of pressurized air delivered through the air supply conduits 42. The air bubbles deliver oxygen to bacteria present in wastewater to break down the pollutants in the pond 20.

The modular aeration unit 12 further comprises a buoyant flotation frame 60, which is formed as a buoyant body capable of floating on the surface 18 in the wastewater pond 20. The flotation frame 60 is secured to the aeration grid member 50 by a plurality of elongated rigid legs 62. The legs 62 are affixed to an underside 64 of the flotation frame 60 and to the aeration grid 50 thus retaining the aeration grid member 50 and the flotation frame 60 in a spaced-apart relationship.

Depending on the depth of the pond 20, the legs 62 can be between 64″ to 88″. Of course, other lengths can be selected if desired. The legs 62 are configured to retain the aeration grid member 50 well below the surface 18 of the wastewater pond 20. The flotation frame 60 retains the aeration grid member 50 afloat, albeit below the surface. As the air bubbles rise to the surface from the aeration grid member 50, the bacteria in the wastewater, fueled by the oxygen in the air flow, breaks down the pollutants. This process enables the pollutant to escape the wastewater either by aspiration or as a further food source for the bacteria in the pond. The pollutants can then be removed from the pond 20 by conventional means.

The legs 62 can be formed from a rigid material not readily susceptible to bending, such as metal, plastic, etc. In one aspect of the invention, the legs 62 are formed as hollow tubular members having an outside diameter of about 3.5″, the inside diameter of about 2.4″ and a wall thickness of about 0.5″.

The flotation frame 60 can be formed from sections of tubular material capable of supporting the flotation frame 60 on the surface 18. In one aspect of the invention, the flotation frame 60 has a generally rectangular or square configuration and made up of four sections, each having a length of about 5 feet. The tubular member 63 forming the flotation frame 60 can have about 4.5″ in outside diameter, about 3.6″ ID and a wall thickness of about 0.4″. The tubular members 63 provide sufficient buoyancy to the aeration grid member to retain the modular unit 12 above the floor 16 of the wastewater pond 20.

The tubular member 63 of the flotation frame 60 are connected by standard elbow joints 65, with the outside diameter of about 4.5″, the inside diameter of about 3.6″, and a wall thickness of about 0.4″. Standard reducing tees can be used for connection of the flotation frame 60 to the legs 62. Similar reducing tees can be used for securing the legs 62 to the aeration grid member 50.

The bubbles produced by the aeration grid member 50 can be fine or coarse bubbles. In one aspect of the invention, the produced bubbles are about 3 mm in diameter. The aeration conduits 54 have a burst rating of 80 p.s.i. and an operating pressure of less than 3 p.s.i. If necessary, air control valves can be positioned in the air lines between the blower, the central air conduit and air supply conduits.

The waste treatment system 10 is adjustable in length so there is little risk of the delivery system becoming clogged like in other aeration systems currently in use. In addition, numerous modular units 12 can be connected together to further maximize dissolved oxygen efficiency. The system 10 is portable and does not require chemical cleaning because it can be cleaned with a pressure washer making it more environmentally friendly. By arranging several pods together, the waster water is forced to flow from one unit to another thus forcing the flow of waste water through multiple modular units before being discharged, thereby extending the retention and treatment.

It is envisioned that one of the advantages of the system of the present invention is reduction in the cost of operation due to lower electricity consumption. The operational elements of the system 10 are made of non-corrosive materials, such as stainless steel, plastic, and others. Furthermore, the modular units 12 can be installed and connected in any desired configuration to deliver oxygen to all parts of the wastewater pond.

Many changes and modifications can be made in the system of the present invention without departing from the spirit thereof. I, therefore, pray that my rights to the present invention be limited only by the scope of the appended claims.

I claim:

1. A wastewater treatment system for deployment within a pond having a floor and a wastewater surface, the system comprising:
a plurality of floating modular aeration units, each of said modular aeration units being connected to a central air conduit and being configured to form air bubbles below the wastewater surface;
a means for delivering pressurized air to each of said modular aeration units.

2. The system of claim 1, wherein said means for delivering pressurized air comprises a blower powered by a motor, said blower having an air inlet line and an air outlet line, said air outlet line being fluidly connected to the central air conduit.

3. The system of claim 2, wherein said means for delivering pressurized air further comprises an air filter assembly connected to the inlet line.

4. The system of claim 1, wherein each of said modular aeration units comprises a buoyant frame configured to float on the wastewater surface, an aeration grid member connected to the buoyant frame, and a means for retaining the aeration grid member below the wastewater surface

5. The system of claim 5, wherein said means for retaining the aeration grid member below the wastewater surface comprises a plurality of rigid legs extending between the buoyant frame and the aeration grid member, each of said legs having a discreet length.

6. The system of claim 5, wherein said aeration grid member is configured to create air bubbles at a pre-determined depth below the wastewater surface.

7. The system of claim 5, wherein said aeration grid member is fluidly connected to the central air conduit by a separate air supply conduit.

8. The system of claim 5, wherein the buoyant frame is formed as a buoyant body capable of floating on the wastewater surface and supporting the aeration grid member at a pre-determined depth below the wastewater surface.

9. The system of claim 8, wherein said buoyant frame is formed from tubular buoyant members having sufficient buoyancy to retain the aeration grid member above the floor of the pond.

10. A wastewater treatment system for deployment within a pond having a floor and a wastewater surface, the system comprising:
a plurality of floating modular aeration units, each of said modular aeration units being connected to a central air conduit, each of said modular aeration units comprising an aeration grid retained below the wastewater surface and configured to form air bubbles below the wastewater surface;
a means for delivering pressurized air to each of said modular aeration units, said means for delivering pressurized air comprises a blower powered by a motor, said blower having an air inlet line and an air outlet line, said air outlet line being fluidly connected to the central air conduit.

11. The system of claim 10, wherein each of said modular aeration units further comprises a buoyant frame formed as a buoyant body capable of floating on the wastewater surface and supporting the aeration grid member at a pre-determined depth below the wastewater surface.

12. The system of claim 11, wherein said buoyant frame is formed from tubular buoyant members having sufficient buoyancy to retain the aeration grid member above the floor of the pond.

13. The system of claim 11, wherein each of the modular aeration units comprises a plurality of rigid legs extending between the buoyant frame and the aeration grid member, said legs being configured to retain the aeration grid member at the pre-determined depth below the wastewater surface.

14. The system of claim 10, wherein said aeration grid member is fluidly connected to the central air conduit by a separate air supply conduit.

15. The system of claim 10, wherein said means for delivering pressurized air further comprises an air filter assembly connected to the inlet line.
